(19) United States
(12) Patent Application Publication
(10) Pub. No.: US 2009/0051950 A1
(43) Pub. Date: Feb. 26, 2009

(54) IMAGE FORMING APPARATUS

(76) Inventor: Mikimasa Honma, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/015,971

(22) Filed: Jan. 17, 2008

(30) Foreign Application Priority Data
Aug. 22, 2007 (JP) 2007-215800

(51) Int. Cl. G06K 15/02

(52) U.S. Cl. 358/1.11; 358/1.2

(57) ABSTRACT

Disclosed is an image forming apparatus which combines a character string image with an image of image data and forms a combined image, including: a display section to display the character string image; and a control section to generate the character string image to be combined to the image and to display the character string image on the display section, wherein the control section controls the display section to display the character string generated with same font data as font data used for forming the character string image of the combined image on a sheet.

### BACKGROUND

1. Field of the Invention

The present invention relates to an image forming apparatus which combines a character string image with an image of image data and forms a combined image on a sheet.

2. Description of Related Art

An image forming apparatus has a function to combine a page number or stamp image with an image of image data and form a combined image. Here, a stamp image is an annotation of content of a document, for example, a fixed phrase such as “internal use only”, “reproduction prohibited”, “COPY” etc., a signature which is freely made by a user, and the like. Such character string images are usually formed in a portion of a sheet. By forming an image on a document with a character string image, the usefulness of the document is enhanced, and a user may easily understand a characteristic of the document without reading the content of the document thoroughly.

Techniques for forming an image with a character string image are disclosed by Japanese Patent Application Laid-Open Publications No. 5-216315 and No. 2001-16434 , which describe image forming apparatuses.

According to the image forming apparatus shown in Japanese Patent Application Laid-open Publication No. 5-216315, a character string image may be formed in a desired position accurately without complicated procedures. According to the image forming apparatus shown in Japanese Patent Application Laid-Open Publication No. 2001-16434, in addition to positioning of a character string image, a user may freely adjust the printing density and size thereof. The desired character string image can be combined with an image to be formed and formed on a sheet without ruining an impression of the image.

However, with the image forming apparatuses described in Japanese Patent Application Laid-Open Publications No. 5-216315 and No. 2001-16434, the character string image is displayed on a display screen with a different font from a font used when the character string is actually formed on a sheet. This is caused because the character string image on the display screen uses a monospaced font for displaying, whereas a proportional font is used when the image is formed on a sheet. Another reason is that the resolution of the display screen and that of image forming are different from each other.

In other words, with the image forming apparatuses described in Japanese Patent Application Laid-open Publications No. 5-216315 and No. 2001-16434, a user cannot confirm an output of how a character string image set by the user is actually formed before actually forming the set character string image on a sheet, and thus a character string image may be formed in a form unintended by a user.

### SUMMARY

The present invention has been made in consideration of the above problems, and it is one of main objects to provide an image forming apparatus to actually form a character string image on a sheet in a similar form with a character string image displayed on a display screen of a display section, and to prevent a character string image from being formed in a form unintended by a user.

According to a first aspect of the present invention, an image forming apparatus which combines a character string image with an image of image data and forms a combined image comprises:

a display section to display the character string image; and

a control section to generate the character string image to be combined to the image and to display the character string image on the display section, wherein

the control section controls the display section to display the character string generated with same font data as font data used for forming the character string image of the combined image on a sheet.

According to the above aspect, a character string image such as a page number or stamp image is displayed on the display screen with the same font as a font which is actually used in forming on a sheet.

Consequently, this can prevent a character string image from being formed in a form unintended by a user.

### BRIEF DESCRIPTION OF THE DRAWINGS

FIG. 1 is a block diagram showing a functional structure of an image forming apparatus;

FIG. 2 is a flow chart showing an operation of a page setting;

FIG. 3 is a diagram showing an example of a setting screen;

FIG. 4 is a diagram showing an example of a setting screen;

FIG. 5 is a diagram showing an example of a setting screen;

FIG. 6 is a flow chart showing an operation of setting a stamp;

FIG. 7 is a diagram showing an example of a setting screen;

FIG. 8 is a diagram showing an example of a setting screen;

FIG. 9 is a flow chart showing an operation of editing the stamp;

FIG. 10 is a diagram showing an example of a setting screen;

FIG. 11 is a diagram showing an example of a setting screen;

FIG. 12 is a diagram showing an example of a setting screen; and

FIG. 13 is a diagram showing an example of a setting screen.

### DETAILED DESCRIPTION OF PREFERRED EMBODIMENTS

A structure and operation of a preferred embodiment of an image forming apparatus reflecting an aspect of the invention will be described in detail with reference to the drawings.

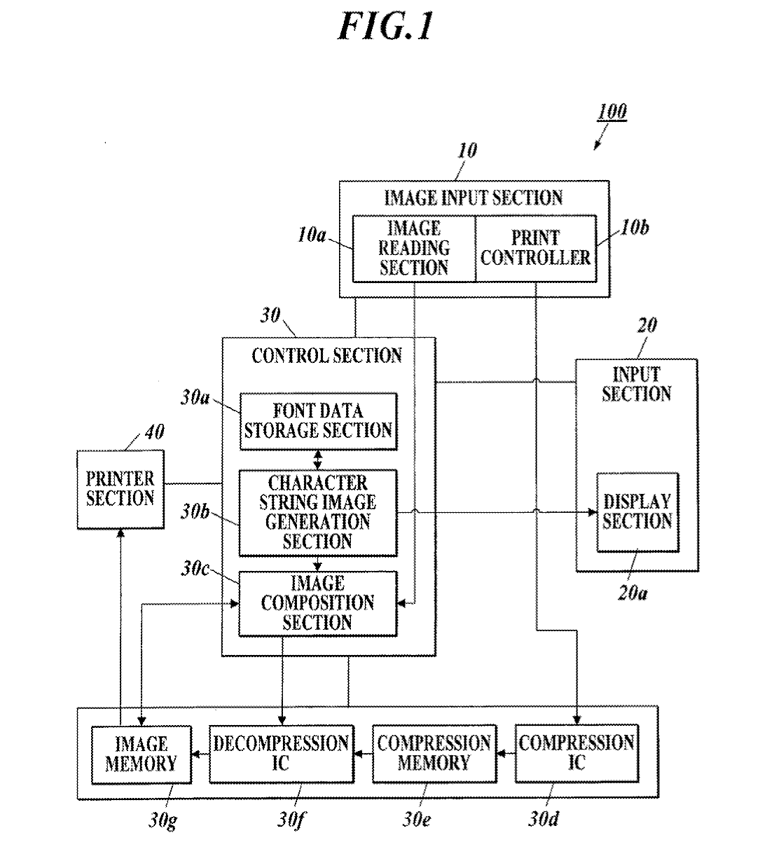

First, an image forming apparatus 100 of this embodiment will be described with reference to FIG. 1.

The image forming apparatus 100 comprises an image input section 10, an input section 20, a control section 30 and a printer section 40.

The image input section 10 comprises an image reading section 10a and a print controller section 10b.

The image reading section 10a reads a character string, etc., printed on a sheet. When reading is performed, the sheet is exposed to light and the reflected light is received by a photoelectric conversion device such as a CCD (Charged Coupled Device) or a CMOS (Complementary Metal-Oxide Semiconductor). This analog electric signal is converted to a digital signal with an A/D converting device and the converted signal is output to the control section 30. This is how the reading processing is performed.

The print controller 10b comprises a LANIF (Local Area Network Interface), etc. The image forming apparatus 100 is connected with a PC (Personal Computer) on a network (not shown) through the print controller 10b so that communication is possible and receives a print job sent from the PC.

The input section 20 is provided with a display section 20a.

The display section 20a comprises an LCD (Liquid Crystal Display) and the like. The display section 20a also comprises an infrared or electrostatic-type touch panel and various operation keys. The input section 20 outputs various operation signals to the control section 30 according to operation by a user.

The control section 30 comprises a font data storage section 30a, a character string image generation section 30b and an image composition section 30c. The control section 30 also comprises a CPU, a RAM, a ROM and the like (not shown) and controls each section of the image forming apparatus 100.

The font data storage section 30a stores font data and outputs necessary font data to the character string image generation section 30b. The font data comprises alphabets, numbers, symbols, etc.

The character string image generation section 30b generates a character string image for displaying on the display section 20a from font data. The character string image generation section 30b outputs the generated character string image to the display section 20a and also to the image composition section 30c. In other words, the character string image generated in the character string image generating section 30b is used for displaying on the display screen 20a and is also used for printing.

The character string image is generated using a proportional font, and is displayed on the display section 20a in a bitmap form. By displaying the character string image like this, the image can be generated with any desired size or resolution.

The image composition section 30c combines an image data input from the image reading section 10a and character string data to be combined with the image data and outputs the image data to a decompression IC 30f.

The control section 30 also comprises a compression IC 30d, a compression memory 30e, the decompression IC 30f and an image memory 30g.

The compression IC 30d performs compression processing of image data output from the print controller 10b and outputs the data to the compression memory 30e.

The compression memory 30e temporarily stores the image data output from the compression IC 30d.

The decompression IC 30f performs decompression processing of compressed image data output from the image composition section 30c or compression memory 30e. After the decompression processing is performed, the data is output to the image memory 30g.

The image memory 30g temporarily stores the input image data and then outputs the data to the printer section 40.

The printer section 40 forms an image of the image data temporarily stored in the image memory 30g according to an instruction from the control section 30.

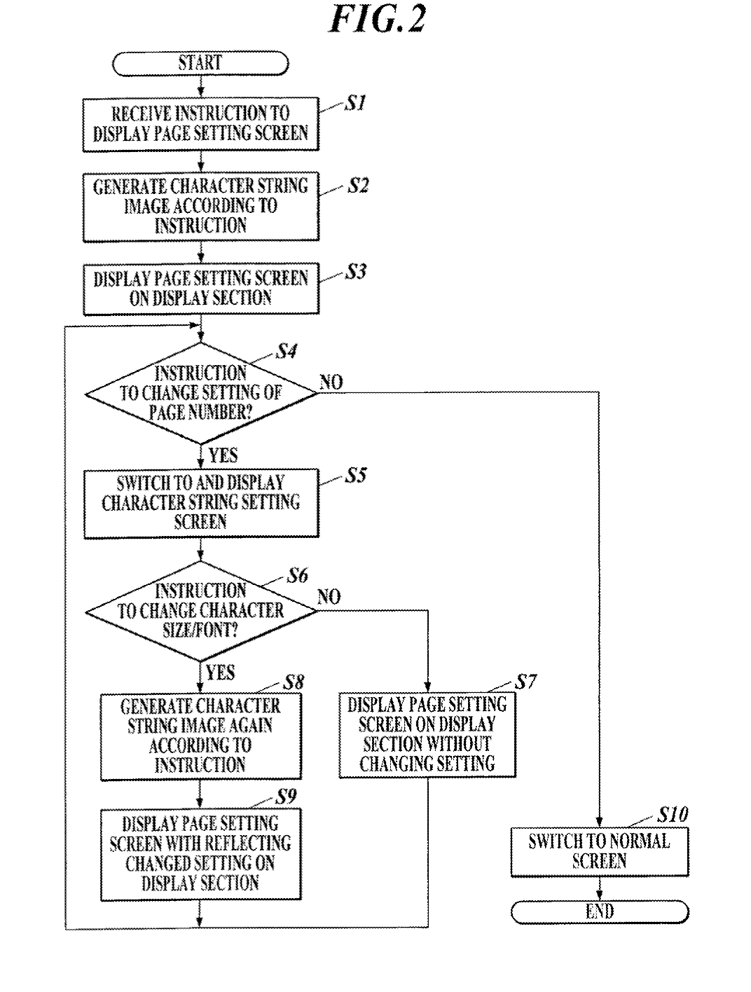

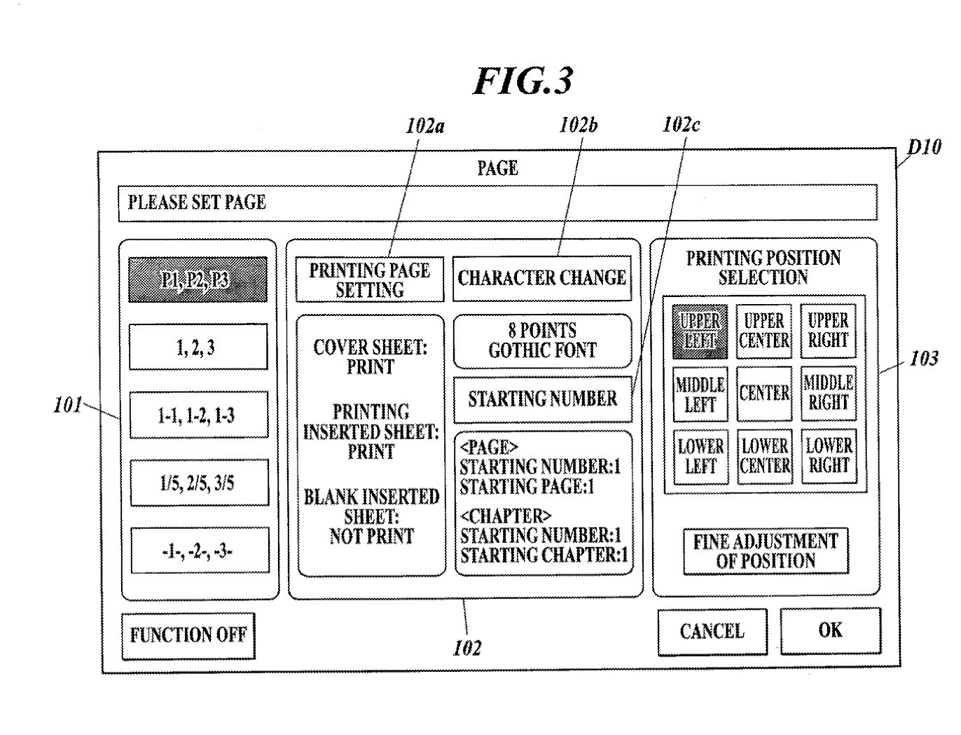

Next, the operation of the image forming apparatus 100 of this embodiment will be described with reference to FIGS. 2, 6 and 9. FIGS. 3-5, FIGS. 7-8, and FIGS. 10-13 are examples of a setting screen displayed on the display section 20a. The processing described below are performed by the control section 30 in coordination with various programs stored in the ROM (not shown) included in the control section 30.

First, FIG. 2 shows a setting operation when the character string image is a page number.

When the control section 30 receives an instruction to display a page setting screen (step S1), the control section 30 generates a character string image to be displayed on the page setting screen (step S2).

The control section 30 controls the display section 20a to display the page setting screen as well as the generated character string image (step S3).

FIG. 3 shows a page setting screen D10.

The page setting screen D10 includes a page number display area 101 a character string setting area 102 and a position setting area 103.

The page number display area 101 displays a character string image showing a page number. The character string image displayed here reflects the content set in the character string setting area 102.

Setting buttons for setting the character string image and the set content are displayed in the character string setting area 102. Setting buttons include a printing page setting button 102a, a character change button 102b and a start number setting button 102c.

The printing page setting button 102a is pressed down when setting whether or not to form an image of the page number on a cover sheet, or whether or not to form an image on an inserted sheet. A display area under the printing page setting button 102a displays the present setting. In FIG. 3, the setting is that the image of the page number is to be formed on the cover sheet and the printing inserted sheet.

The character change button 102b is pressed down when setting a size and font of a character of the page number. The display area under the character change button 102b displays the present setting of the size and font of the character. In FIG. 3, the size of the character is set to 8 points and the font of the character is set to Gothic font.

The character change button 102b, for example, enables a user to unify the font of the character string of the text and the page number to be formed on the sheet or to set the font of the page number to a different font from that of the character string of the text, according to the user's preference.

The start number setting button 102c is pressed down when setting a starting number and a starting page of the page number. The display area under the start number setting button 102c displays the present setting. In FIG. 3, the setting is that an image of a page number is formed from the first page with the starting number “1”.

The position setting area 103 displays a selection button for setting a position on a sheet where an image of the page number is to be formed.

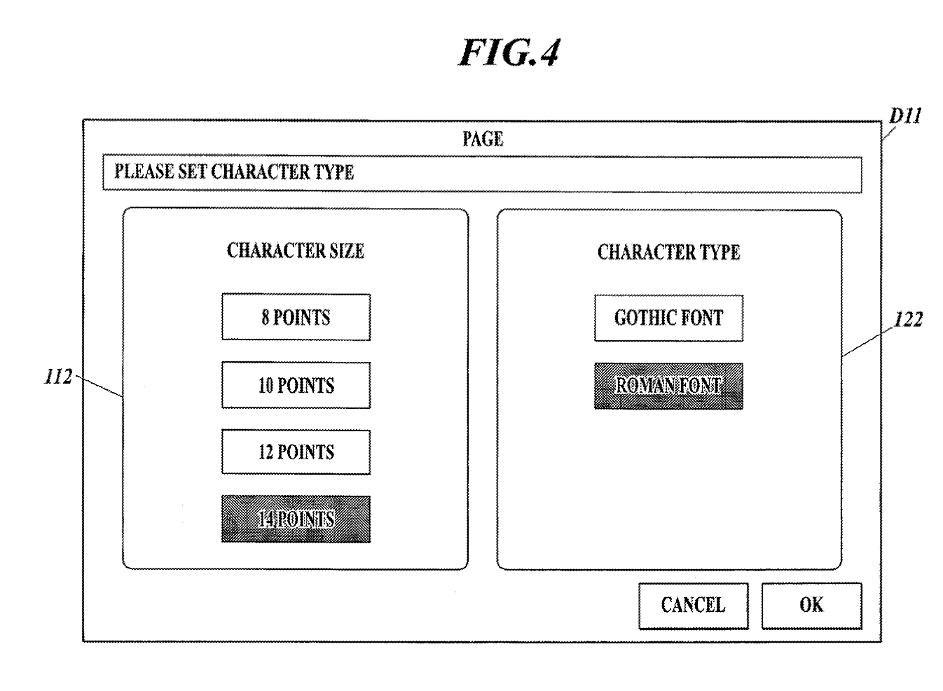

Returning to FIG. 2, when the control section 30 receives an instruction to change the setting of the page number through the input section 20 (step S4; YES), the control section 30 switches the screen from the page setting screen D10 to a character string setting screen (step S5). Specifically, when a user presses down the character change button 102b on the page setting screen D10 displayed on the display section 20a, the later-described character string setting screen shown in FIG. 4 is displayed.

FIG. 4 shows the character string setting screen D11.

The character string setting screen D11 includes a character size changing area 112 and a font changing area 122. The character size changing area 112 displays character sizes to which the setting may be changed. The font changing area 122 displays fonts to which the setting may be changed. In FIG. 4, from the setting of FIG. 3, the character size is changed to 14 points, and the font is changed to Roman font.

When the control section 30 receives an instruction not to change the character size and the font (step S6; NO), according to the instruction, the control section 30 switches the screen from the character string setting screen D11 to the page setting screen D10 (step S7). Specifically, when the user presses down the cancel button in the lower right of the character string setting screen D11, the instruction is output to the control section 30 through the input section 20.

The page setting screen D10 switched by the control section 30 does not reflect the setting temporarily changed on the character string setting screen D11, and the display remains the same as in FIG. 3.

When the control section 30 receives an instruction to change the character size and the font (step S6; YES), the control section 30 generates the character string image again according to the instruction (step S8). Specifically, when a user presses down an OK button in the lower right of the character string setting screen D11, the instruction is output to the control section 30 through the input section 20. Then, according to the instruction, the control section 30 generates a new page number for displaying and forming an image.

Then, the control section 30 switches the screen from the character string setting screen D11 to the page setting screen D10 (step S9). Here, the control section 30 reflects the page number generated in step S8 on the switched and displayed page setting screen D10.

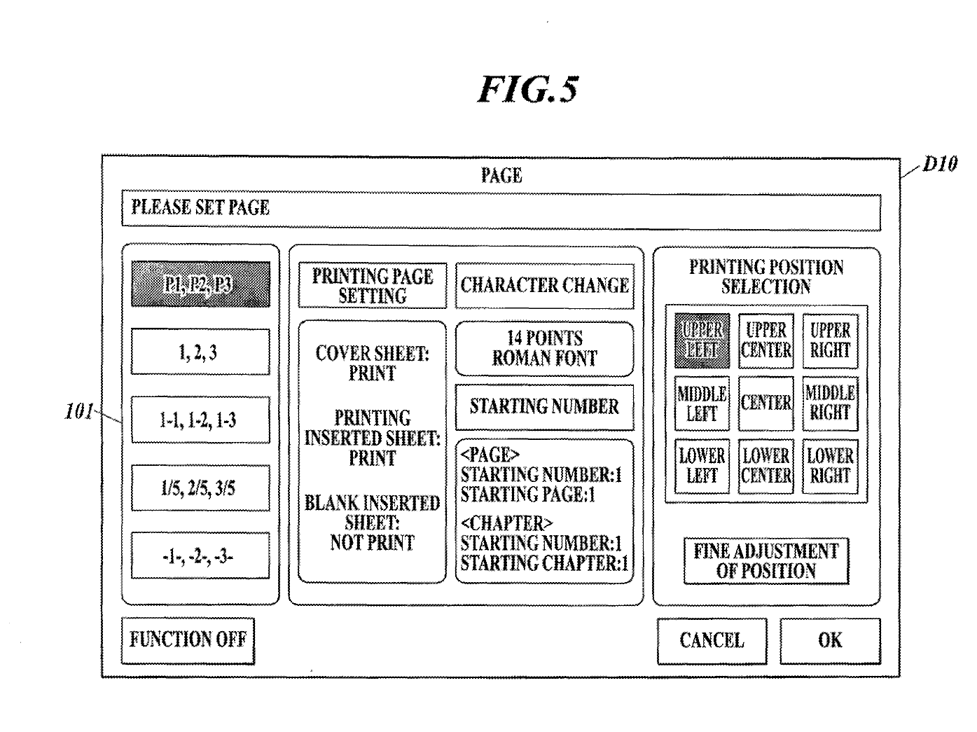

FIG. 5 shows the page setting screen D10 which reflects the setting change.

The page number display area 101 displays the page number which reflects the setting of character size being 14 points and the font being Roman font. The changed character size and font are displayed under the character change button 102b.

Returning to step S4 of FIG. 2, when the control section 30 does not receive the instruction to change the setting of the character string through the input section 20 (step S4; NO), in other words, when a user presses down a cancel button in the lower right of the page setting screen D10, the page setting screen D10 is switched to a usual screen (step S10), and the processing ends.

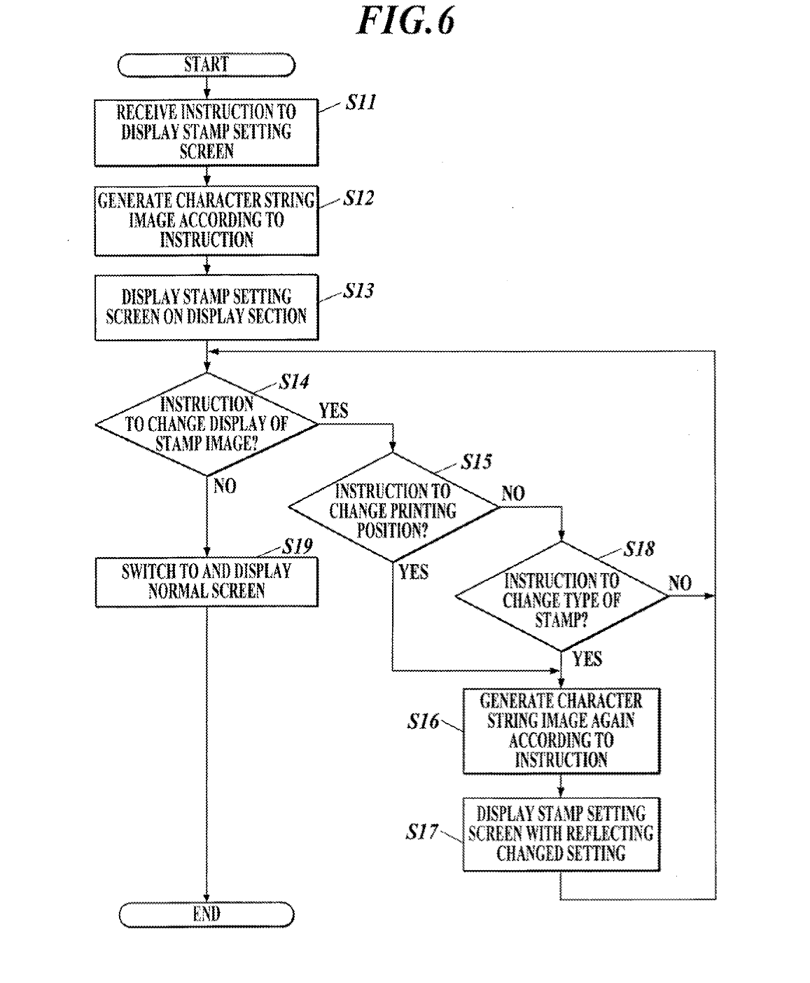

Next, the setting operation of when the character string image is a stamp is described with reference to FIG. 6. When the control section 30 receives an instruction to display a stamp setting screen (step S11, the control section 30 generates the character string image to be displayed on the stamp setting screen according to the instruction (step S12). The instruction includes an instruction to display the stamp setting screen and an instruction to generate the character string image displayed on the setting screen, and the instruction is output to the control section 30 through the input section 20.

Then, the control section 30 controls the display section 20a to display the stamp setting screen (step S13).

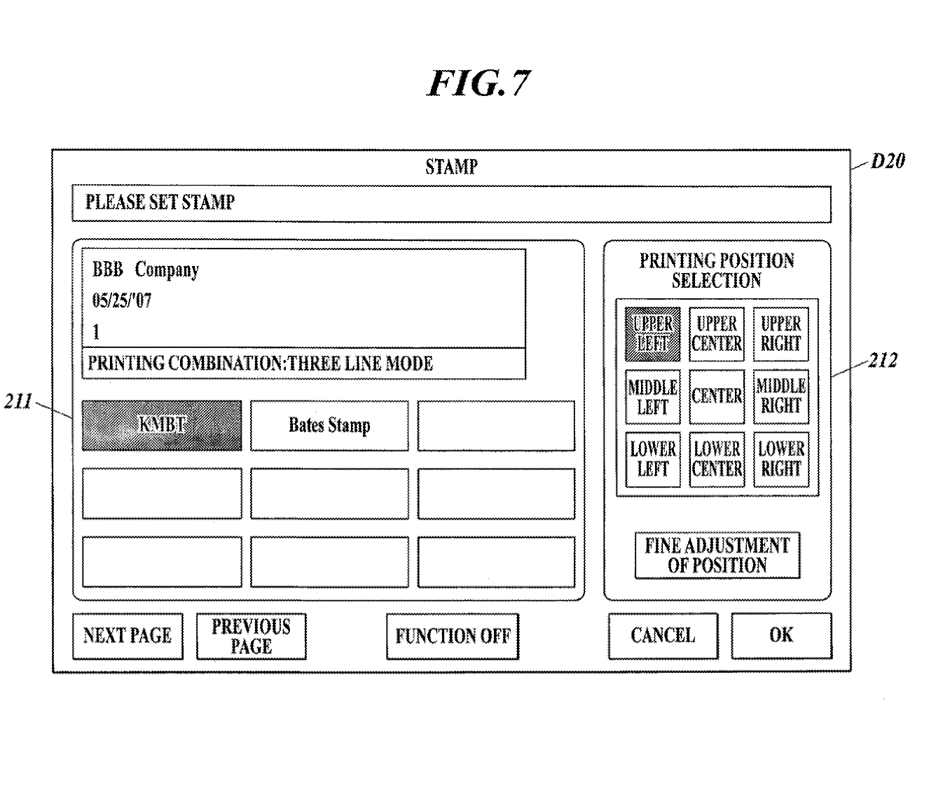

FIG. 7 shows a stamp setting screen D20.

The stamp setting screen D20 includes a stamp display area 211 and a stamp position selection area 212.

The stamp display area 211 displays a stamp image made freely by a user. The character string of the stamp image displayed here is in a proportional font. In FIG. 7, a stamp image with a title “KMBT” is selected and the content of the stamp image is displayed in three lines.

The stamp position selection area 212 displays a position on the sheet which can be selected to form the stamp image. In FIG. 7, “upper left” is selected as a position for the stamp image to be formed, and the stamp image displayed in the stamp display area 211 is displayed with an upper left justification.

Returning to FIG. 6, when the control section 30 receives an instruction to change the display of the stamp image (step S14; YES), the control section 30 determines the content of the instruction and advances to the next processing.

When the control section 30 determines the received instruction is an instruction to change the printing position (step S15; YES), the control section 30 generates the character string image again which is to be displayed on the stamp setting screen D20 according to the instruction (step S16). Then the character string image is updated on the stamp setting screen D20 (step S17).

The instruction is output to the control section 30 through the input section 20 when a user presses down a desired button in the stamp position selection area 212.

When the control section 30 determines the received instruction is an instruction to change the type of stamp image (step S18; YES), the control section 30 generates again the character string image to be displayed on the stamp setting screen D20 according to the instruction (step S16). Then, the character string image is updated on the stamp setting screen D20 (step S17).

The instruction is output to the control section 30 through the input section 20 when a user presses down a desired title in the stamp display area 211.

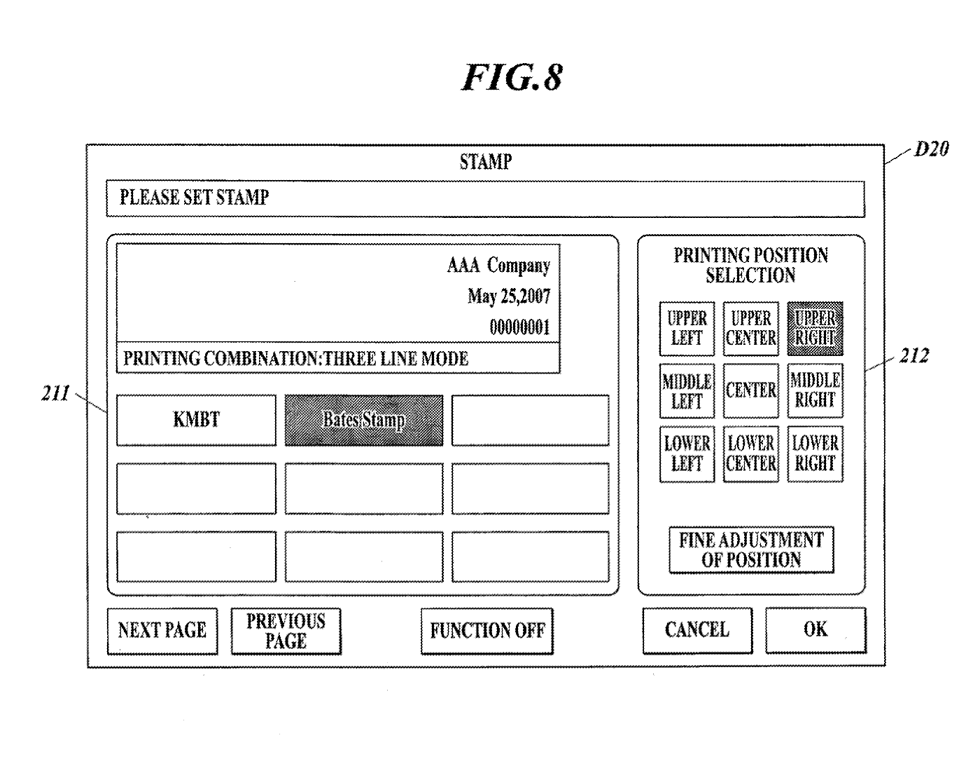

FIG. 8 shows a stamp setting screen D20 in which the printing position and the title of the stamp image is changed.

In the stamp setting screen D20 shown in FIG. 8, “upper right” is selected as the position of the stamp image in the stamp position selection area 212. The stamp image with the title “Bates Stamp” is selected in the stamp display area 211 and the content of the stamp image is displayed in three lines with an upper right justification. The font used in the displayed stamp image is a proportional font.

When the control section 30 receives an instruction not to change the stamp image (step S14; NO), specifically, when a user presses down an OK button or a cancel button in the lower right of the stamp setting screen D20, the stamp setting screen D20 is switched to a normal screen (step S19) and the processing ends.

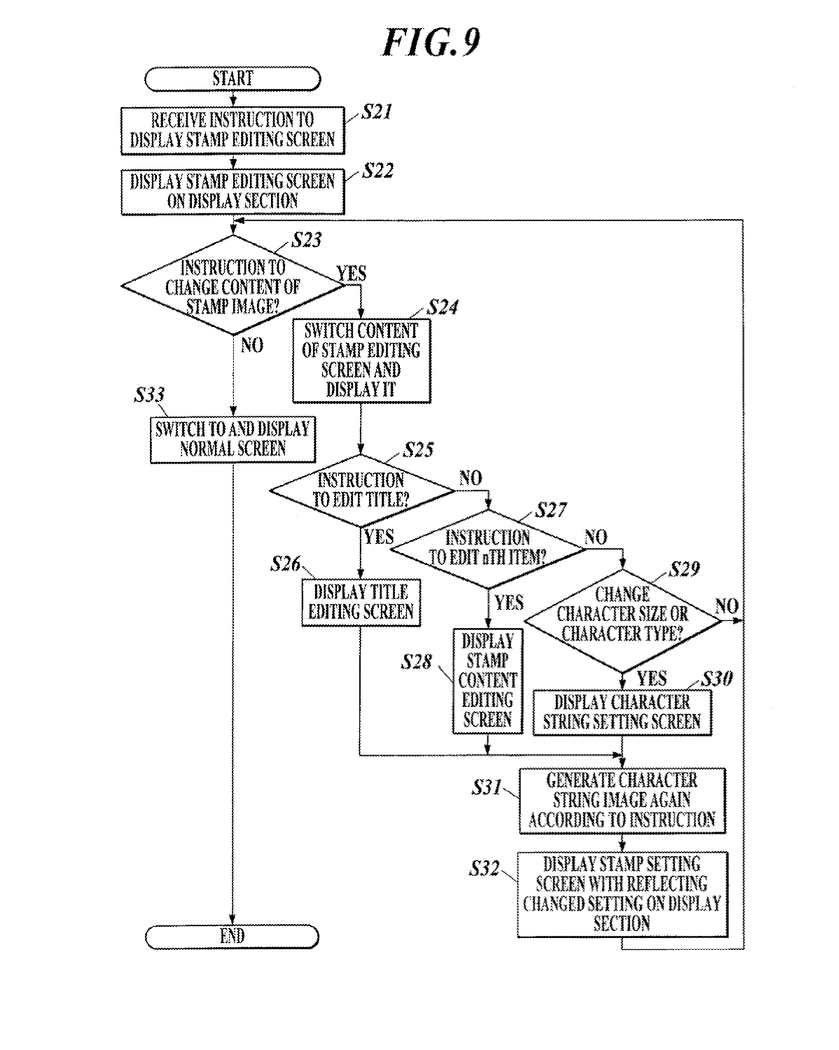

Next, the operation of editing the stamp image is described with reference to FIG. 9.

When the control section 30 receives an instruction to display a stamp editing screen (step S21), the control section 30 controls the display section 20a to display the stamp editing screen (step S22).

When the control section 30 receives an instruction to change the content of the stamp image (step S23; YES), the content of the stamp editing screen are switched and displayed according to the instruction (step S24).

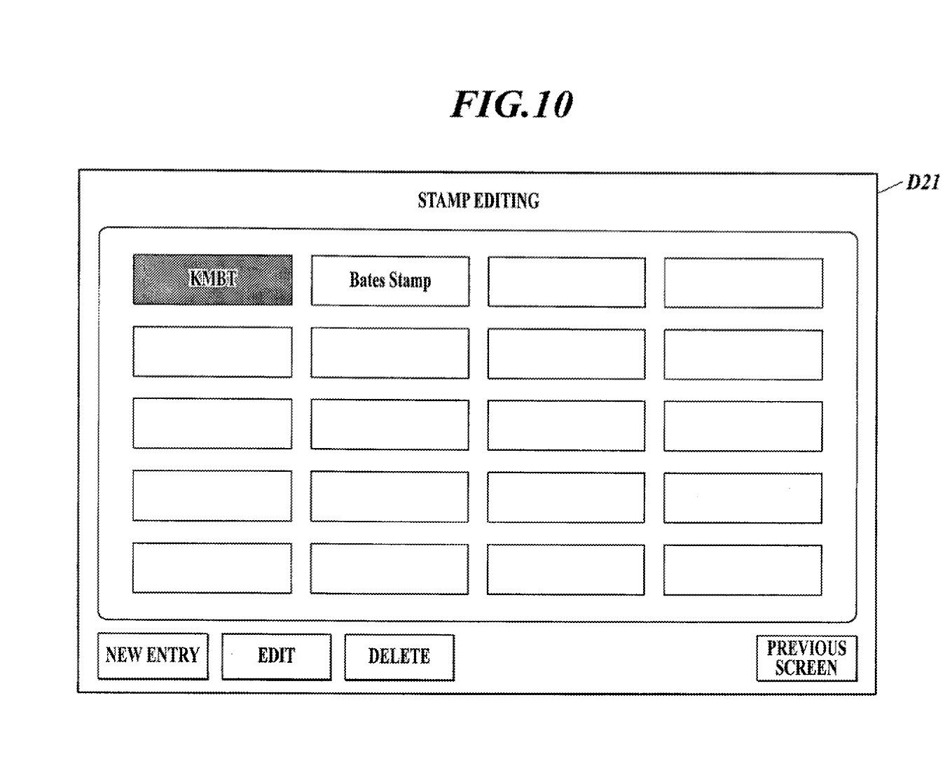

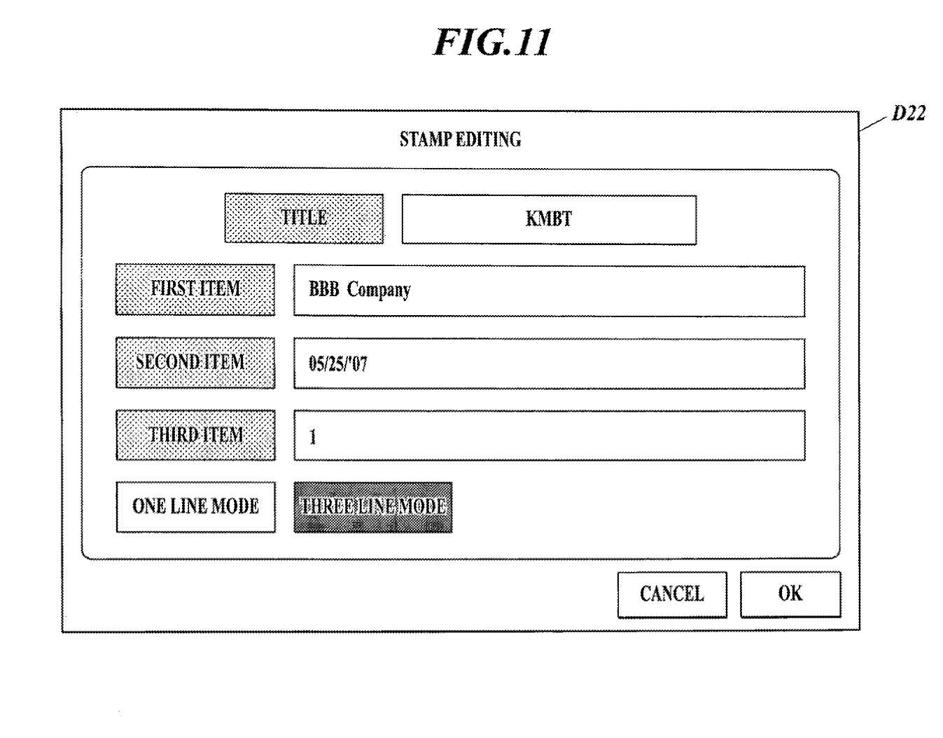

FIG. 10 and FIG. 11 show stamp editing screens.

The stamp editing screen D21 shown in FIG. 10 displays a title of the stamp image. After a user selects a title, when an “edit” button in the lower area of the editing screen D21 is pressed down, the display is switched to a later-described stamp editing screen D22 shown in FIG. 11.

The stamp editing screen D22 shown in FIG. 11 displays the title and the content of the stamp. A button which enables selection of whether to display the content of the stamp in one line or three lines is displayed. The character string image displayed on the stamp editing screen D22 shown in FIG. 11 may be displayed using a proportional font.

When the control section 30 receives an instruction to edit the title through the input section 20 (step S25; YES), the control section 30 controls the display section 20a to display a title editing screen according to the instruction (step S26).

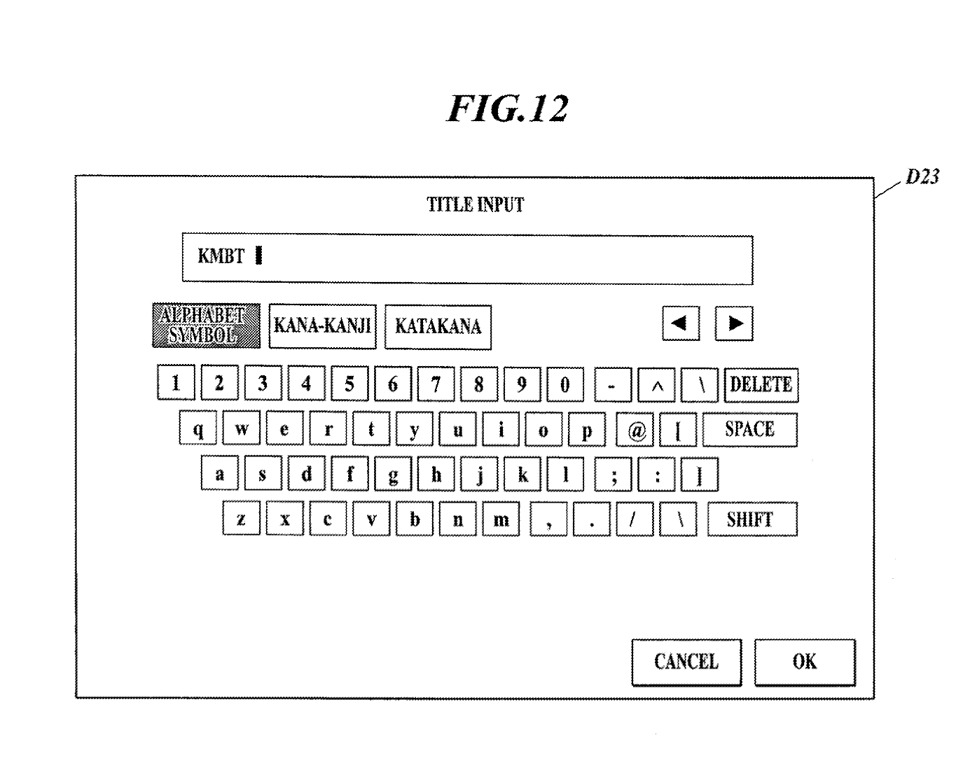

FIG. 12 shows a title editing screen D23.

The title editing screen D23 shows a conceptual image of a keyboard. A user may press down any button on the keyboard and a character string is displayed in the display area above the keyboard. The font of the character string displayed here may be a monospaced font or a proportional font. The image of the character on the button of the keyboard may be made with the font data used for printing.

When the control section 30 receives an instruction through the input section 20 to edit the content of the stamp image (step S27; YES), according to the instruction, the control section 30 controls the display section 20a to display a stamp content editing screen (step S28).

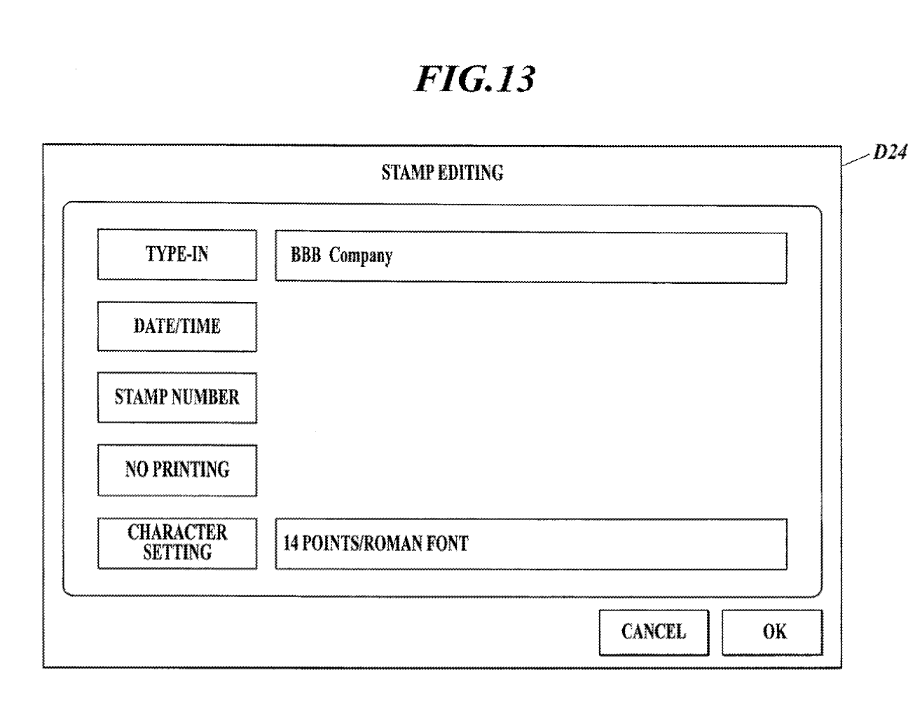

FIG. 13 shows a stamp content editing screen D24.

The stamp content editing screen D24 is a setting screen which is displayed when a user selects an nth item (n=1-3) in the stamp editing screen D22 shown in FIG. 11. In the stamp content editing screen D24, buttons such as type-in, date/time, stamp number, character setting, etc. are displayed.

When the type-in button is pressed down, a screen similar to the title editing screen D23 shown in FIG. 12 is displayed.

When the date/time button is pressed down, the present date or time is displayed.

When the stamp number button is pressed down, a number concerning an order of a title displayed on the stamp editing screen D21 shown in FIG. 10 is displayed.

When a character setting button is pushed down, a screen similar to the character string setting screen D11 shown in FIG. 4 is displayed.

When the control section 30 receives an instruction which instructs the editing of the character string of the stamp image through the input section 20 (step S29; YES), the control section 30 controls the display section 20a to display the character string setting screen D11 shown in FIG. 4 according to the instruction (step S30).

According to the above-described instruction which instructs the editing of the stamp image, the control section 30 generates the character string image again (step S31). Then, the character string image is updated and reflected on the stamp setting screen D20 shown in FIG. 7 or FIG. 8 and displayed (step S32).

In step S23, when the control section 30 receives an instruction not to change the content of the stamp image (step S23; NO), specifically, when a user presses down the OK button or the cancel button in the lower right of the stamp setting screen D20, the stamp setting screen D20 is switched to the normal screen (step S33) and the processing ends.

As described above, according to an aspect of a preferable embodiment, there is provided an image forming apparatus 100 which combines a character string image with an image of image data and forms a combined image comprising:

a display section 20a to display the character string image; and

a control section 30 to generate the character string image to be combined to the image and to display the character string image on the display section, wherein

the control section 30 controls the display section 20a to display the character string generated with same font data as font data used for forming the character string image of the combined image on a sheet.

According to the above-described image forming apparatus 100, a user can easily grasp the condition of the image when the image is actually formed on a sheet by looking at the character string image displayed on the page setting screen D10 or the stamp setting screen D20. Consequently, this prevents sheets from being wasted.

Preferably, the image forming apparatus 100 further comprises an input section 20 to receive an input of an image forming condition of the character string image, wherein

the control section 30 generates the character string image again based on an image forming condition input through the input section 20 and controls the display section 20a to update the character string image.

According to the above-described image forming apparatus 100, a user can easily grasp the character string image to be formed on a sheet on the page setting screen D10 or the stamp setting screen D20 even after the setting is changed.

Preferably, in the image forming apparatus 100, the image forming condition includes at least one of content, a font type, a printing position, a size or a color of the character string image.

According to the above-described image forming apparatus 100, the image forming condition which can be set on the page setting screen D10 or the stamp setting screen D20 can be the content, the font type, the printing position, the size, the color, etc. of the character string image. Consequently, a user can confirm on the screen the character string image which is actually formed on the sheet.

Preferably, in the image forming apparatus 100, the image forming condition includes a setting of whether or not to form the character string image on a cover sheet and a setting of whether or not to form the character string image on an inserted sheet.

According to the above-described image forming apparatus 100, whether or not to form an image of the page number on the cover sheet or the inserted sheet can be set on the page setting screen D10.

Preferably, in the image forming apparatus 100, the control section 30 controls the display section 20a to display the character string image with a size corresponding to a size of the character string image to be formed on the sheet and a resolution different from the character string image to be formed on the sheet.

According to the above-described image forming apparatus 100, the proportional font can be used as the font for the character string image and the character string image can be displayed on the screen in bit-map format.

Preferably, in the image forming apparatus 100, the character string image is a digital watermark.

According to the above-described image forming apparatus 100, the character string image is not limited to page number or stamp image, and may be a watermark.

The present U.S. Patent Application claims priority under the Paris Convention of Japanese Patent Application No. 2007-215800 filed on Aug. 22, 2007 to the Japanese Patent Office, which shall be a basis for correcting mistranslations.

What is claimed is:

1. An image forming apparatus which combines a character string image with an image of image data and forms a combined image, comprising:
a display section to display the character string image; and
a control section to generate the character string image to be combined to the image and to display the character string image on the display section, wherein
the control section controls the display section to display the character string generated with same font data as font data used for forming the character string image of the combined image on a sheet.

2. The image forming apparatus of claim 1, further comprising an input section to receive an input of an image forming condition of the character string image, wherein
the control section generates the character string image again based on an image forming condition input through the input section and controls the display section to update the character string image.

3. The image forming apparatus of claim 2, wherein the image forming condition includes at least one of content, a font type, a printing position, a size or a color of the character string image.

4. The image forming apparatus of claim 2, wherein the image forming condition includes a setting of whether or not to form the character string image on a cover sheet and a setting of whether or not to form the character string image on an inserted sheet.

5. The image forming apparatus of claim 1, wherein the control section controls the display section to display the character string image with a size corresponding to a size of the character string image to be formed on the sheet and a resolution different from the character string image to be formed on the sheet.

6. The image forming apparatus of claim 1, wherein the character string image is a digital watermark.
